(19) United States
(12) Patent Application Publication
(10) Pub. No.: US 2025/0314320 A1
(43) Pub. Date: Oct. 9, 2025

(54) MICRODOSING VALVE

(71) Applicant: USTER S.R.L., Monastier di Treviso (TV) (IT)

(72) Inventors: Mario PELLIN, Monastier di Treviso (TV) (IT); Daniele PELLIN, Monastier di Treviso (TV) (IT)

(21) Appl. No.: 18/873,147

(22) PCT Filed: Jun. 9, 2023
(86) PCT No.: PCT/IB2023/055973

§ 371 Date: Dec. 9, 2024

(30) Foreign Application Priority Data
Jun. 9, 2022 (IT) 102022000012254

(51) Int. Cl. F16K 21/16; F16K 31/04; G01F 15/00

(52) U.S. Cl. CPC F16K 21/16; F16K 31/04; G01F 15/005

(57) ABSTRACT

It is a valve preferably used for microdosing of fluids, having extreme precision in the timing of opening and closing of a fluid passageway by suitable closing means. The microdosing valve according to the invention does not require any particular maintenance and its operation is precisely and quickly adjustable, particularly in terms of the movement and force of the closing means.

The present invention relates generally to a microdosing valve. More particularly, it is a valve preferably used for microdosing of fluids.

Microdosing valves are known to be used to allow a fluid to pass through so as to regulate its dosage, for example, in a chemical handling apparatus.

Since such valves are used for dosing very small quantities of fluid, they are required to be extremely precise in their opening and closing times.

A problematic issue with known micro-dosing valves is therefore their limited precision, which rules out their use in state-of-the-art equipment.

A further problem with known micro-dosing valves is the wear and tear on the components: in fact, these valves are usually subjected to rather sustained work cycles, e.g. hundreds of cycles per minute, with continuous stress on the various parts.

A further issue with known micro-dosing valves, e.g. pneumatic valves, relates to the need to carry out an initial adjustment, so as to verify the actual correspondence between the movement of the valve and the quantity of liquid dosed.

Patent document U.S. Pat. No. 7,147,205B1 describes a valve with a miniaturised diaphragm controlled by a motor, specifically a micro-motor gearbox that rotates a shaft which is in turn connected to a drive screw. This rotation advances or retracts a piston that moves the valve diaphragm. However, this configuration is rather complex and the valve thus realised is not very precise.

Patent document US2020278234A1 discloses a valve whose diaphragm is indirectly controlled by a piezoelectric actuator acting on a presser. This configuration, in addition to being rather complex, does not allow the force on the presser to be metered and does not permit double-acting operation.

Patent document EP2413008A1 describes a valve whose diaphragm is set in motion indirectly by an electromechanical actuator. Specifically, such an electromechanical actuator is a stepper motor. Consequently, such a valve cannot perform dosing, but can only be opened or closed.

The purpose of the invention is to eliminate the problems present in micro-dosing valves made according to the known technique.

In particular, an object of the invention is to obtain a microdosing valve having a high accuracy in dosing the liquid.

Another purpose of the invention is to obtain a microdosing valve whose high accuracy is also repetitive.

A further scope of the invention is to obtain a micro-dosing valve comprising low-wear operating parts, ensuring millions of cycles of maintenance-free operation.

Yet another purpose of the invention is to provide a micro-dosing valve in which initial manual adjustments are avoided, so that the operation of the entire dosing apparatus is more efficient.

These and other purposes are achieved, according to the invention, by a microdosing valve for dosing a fluid comprising:
an internally hollow valve body
a valve head, connected to the valve body and having a fluid passageway;
means for closing the passage conduit;
a coupling connected to the closing means and housed in the valve body.

The microdosing valve according to the invention is characterised in that it comprises a linear motor comprising a motor body fixed to the valve body, and a stem, movable with respect to the motor body. In particular, the stem is connected to the coupling, so that upon actuation of the linear motor, the coupling translates and the closing means open or close the passageway.

In particular, the linear motor is a permanent magnet with the advantages that this brings. In fact, with the use of a permanent magnet linear motor, it is possible to programme the force, position, speed and acceleration of the piston to which the motor is connected.

In fact, thanks to the use of a permanent magnet linear motor, the stroke and force of the coupling can be adjusted very quickly and very precisely, even to hundredths of a millimetre.

In addition, the movement of the linear motor's stem, and thus the movement of the clamping means, is very fast, making microdosing very precise and this perfect measurement repeatable.

These adjustments and actuations are easy to manage as the linear motor can be connected to a controller, which controls the stroke and/or stem force of the linear motor.

Advantageously, the closing means may include a diaphragm, but may also feature other closing devices such as a pin.

In addition, the valve body may contain, contiguous and coaxial
a first cylindrical bore in which a cylindrical end of the linear motor is accommodated;
a second cylindrical bore in which the coupling is accommodated.

In this way, the coupling can translate between a first position in which the passageway is intended to be open and a second position in which the passageway is intended to be closed and the coupling is in contact with the bottom of this second cylindrical hole.

Advantageously, the coupling may comprise an outer cylindrical portion capable of abutting the bottom of the second cylindrical hole.

Furthermore, for safety reasons, elastic means, for example a spring, may be included between the motor body and the coupling, so that, when the linear motor is not driven and the rod is free to move, the coupling is pushed by the elastic means so that the closing means close the passageway.

For ease of construction, the spring means can be pressurised on the outer cylindrical portion.

In order to minimise wear on the valve, a support ring can be pressed against the cylindrical end of the linear motor, which in turn is pressed against the first end of the spring; the opposite end of the spring can be pressed against a bushing, which is pressed against the lower portion of the coupling and against the outer cylindrical portion of the coupling.

Advantageously, the linear motor may be single-acting or double-acting.

Further features and details of the invention may be better understood from the following description, given by way of non-limiting example, as well as from the accompanying drawing plates wherein

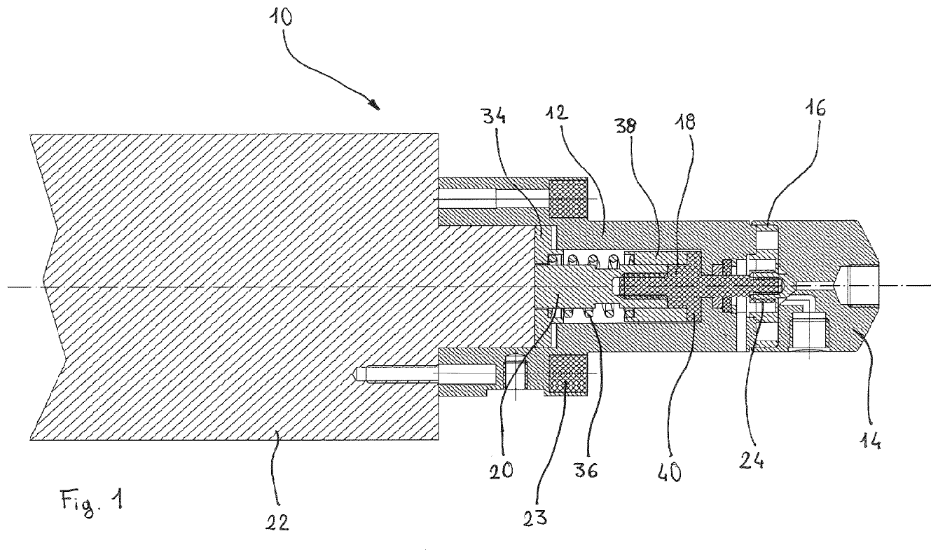

FIG. 1 is a side sectional view of a diaphragm valve according to the invention;

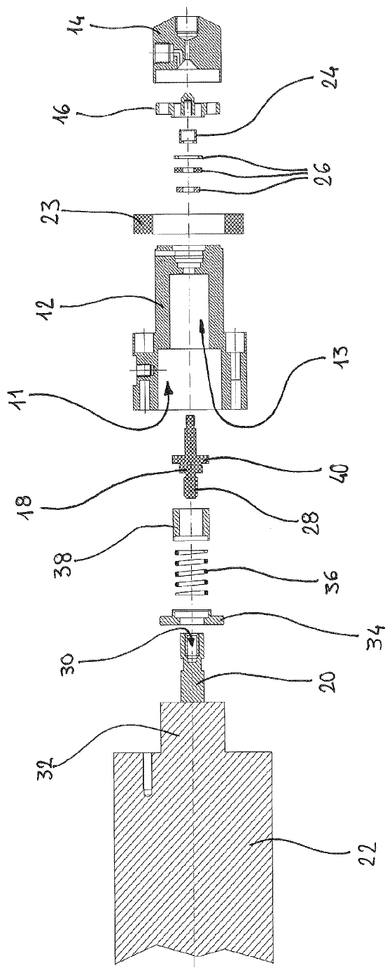

FIG. 2 is an exploded sectional side view of the diaphragm valve of FIG. 1.

With reference to the appended figures, 10 denotes a micro-dosing valve, in particular a diaphragm valve, comprising an internally hollow valve body 12, closed at the top by a valve head 14.

A first cylindrical bore 11 and a second cylindrical bore 13 are provided in the valve body 12, which are contiguous and coaxial with each other, the first cylindrical bore 11 having a larger diameter than the second cylindrical bore 13.

Between the valve body 12 and the valve head 14 is arranged a diaphragm 16, centrally constrained to a coupling 18, capable of translating inside the valve body 12.

The coupling 18 is, therefore, constrained superiorly to the diaphragm 16 and inferiorly to a stem 20 of a linear motor 22 with permanent magnets, to which the valve body is fixed by means of appropriate screws and to a closing disc 23.

In particular, the end of the coupling 18 is permanently fixed to the diaphragm 16 by means of a reinforcing ring 24.

In addition, the upper portion of the joint 18 shifts securely by means of sealing rings 26.

The displacement of the joint 18 causes a change in the positioning of the diaphragm 16, which allows the passage of a fluid into the ducts formed in the valve head 14.

15 The elements just illustrated as well as the conformation of the upper portion of the diaphragm valve 10 and of the conduits present in the valve head 14 are the subject matter of U.S. Pat. No. 1,401,635 in Italy and of European patent No. EP2416039 in the name of the owner of the present invention, and reference is therefore made to said patent titles.

The configuration of the portion of the diaphragm valve 10 opposed to the valve head 14, as well as the devices enabling its operation are, however, different from what is illustrated in the patent in Italy No. 1401635 and European patent No. EP2416039.

The coupling 18 is fixed to the stem 20 of the linear motor 22 by means of a threaded end 28, which is screwed into a threaded hole 30 formed in the same stem 20.

In addition, the linear motor 22 includes a cylindrical end 32 which is received in the first cylindrical bore 11 of the valve body 12.

On the cylindrical end 32, a support ring 34 is arranged in rebate on which, in turn, a first end of a spring 36 goes in rebate.

The opposite end of the spring 36 goes into contact with a bushing 38, which is inserted into the lower portion of the joint 18 and into contact with an outer cylindrical portion 40 of the same joint 18.

Due to the presence of the spring 36, when the linear motor 22 is uncontrolled, and therefore the stem 20 is free to move, the spring 36 itself pushes the coupling 18 towards the valve head 14, so that the diaphragm 16 keeps the ducts of the same valve head 14 closed.

Linear motor 22 is a permanent magnet linear motor, of the electric motor category, and allows for rectilinear movement of an element, previously defined as stem 20.

The linear motor 22 is controlled by a controller, possibly connected to a personal computer. In this way, the stroke of the stem 22 can be easily and quickly set, as can the force of the stem 22 itself.

In this way, the adjustment of the micro-dosing valve 10 is fast and precise, thus avoiding all the adjustments that have to be made in the case of a known type of valve, in which even the adjustment is made manually.

According to a variant of the invention, a microdosing valve comprises means for closing a passage other than a diaphragm, for example a pin or other elements.

Such closing means are, however, connected to a linear motor, so that their position can be varied in a precise, repeatable and extremely fast manner.

Further variants and embodiments are possible which are to be considered within the scope of protection of the invention: for example, the shape and position of the linear motor, as well as of the coupling between the linear motor and the closing means, for example a diaphragm or a pin, may be different from those previously described and illustrated.

Furthermore, a microdosing valve according to the invention may comprise a linear motor, not only single-acting, but also double-acting.

1. Microdosing valve (10) for dosing a fluid, comprising
a valve body (12) internally hollow
a valve head (14), connected to the valve body (12) and having a conduit for passage of fluid;
closing means (16) of the passage conduit;
a joint (18) connected to the closing means (16) and enclosed in the valve body (12);
said microdosing valve (10) characterised by comprising a linear motor (22) comprising
a motor body fixed to the valve body (12);
a stem (20), movable relative to the motor body;
the stem (20) being connected to the joint (18), so that when the linear motor (22) is actuated, the joint (18) moves and the closing means (16) open or close the passageway.

2. Microdosing valve (10) according to claim 1, wherein the linear motor is singleacting.

3. Microdosing valve (10) according to claim 1, wherein the linear motor is doubleacting.

4. Microdosing valve (10) according to claim 1, wherein the closing means comprise a diaphragm (16).

5. Microdosing valve (10) according to claim 1, wherein in the valve body (12) are obtained, contiguous to each other and coaxial to each other,
a first cylindrical bore (1 1) in which a cylindrical end (32) of the linear motor (22) is received;
a second cylindrical bore (13) in which the coupling (18) is allowed to move between a first position in which the passageway is intended to be opened and a second position in which the passageway is intended to be closed and the coupling is abutted at the bottom of this second cylindrical bore (13).

6. Microdosing valve (10) according to claim 5, wherein the coupling (18) comprises an outer cylindrical portion (40), suitable for abutting the bottom of said second cylindrical bore (13).

7. Microdosing valve (10) according to claim 1, wherein elastic means (36) arranged between the motor body and the coupling are included, so that, when the linear motor (22) is not driven and the stem (20) is free to move, the coupling (18) is pushed by the elastic means (36) so that the closing means close the passageway.

8. Microdosing valve (10) according to claim 4, wherein the elastic means are placed under pressure on the outer cylindrical portion (40).

9. Microdosing valve (10) according to claim 7, wherein the elastic means comprise a spring (36).

10. Microdosing valve (10) according to claim 9, wherein on the cylindrical end (32) a support ring (34) is disposed in rebate on which, in turn, a first end of the spring (36) goes in rebate, wherein the opposite end of the spring (36) goes in rebate on a bushing (38), threaded into the lower portion of the joint (18) and in rebate on the outer cylindrical portion (40) of the same joint (18).

11. Microdosing valve (10) according to claim 1, wherein the linear motor (22) is driven by a controller.

12. Microdosing valve (10) according to claim 1, wherein the controller controls the stroke and/or stem force (20) of the linear motor (22).
